(19) United States
(12) Patent Application Publication
(10) Pub. No.: US 2007/0250678 A1
(43) Pub. Date: Oct. 25, 2007

(54) Computer system, management computer, storage device and volume allocation confirmation method

(76) Inventors: Atsushi Ueoka, Yokohama (JP); Mitsuru Ikezawa, Sagamihara (JP); Toshio Otani, Kawasaki (JP); Yasunori Kaneda, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/454,861

(22) Filed: Jun. 19, 2006

(30) Foreign Application Priority Data
Apr. 24, 2006 (JP) 2006-119069

(51) Int. Cl. G06F 12/00

(52) U.S. Cl. 711/170

(57) ABSTRACT

When configuring volume allocation on a storage device, it is confirmed that design information on the volume allocation is in compliance with an operational policy of a system and there is no mistake in design so as to configure the volume allocation on the storage device in the case where there is no problem. A computer system including: a host computer 2; a storage device 3 for providing a volume to the host computer 2 via a one network 5; and a management computer 1 connected to the storage device 3 via a network 6, wherein when a storage manager configures volume allocation of the storage device 3, the management computer 1 gathers configuration information on the volume allocation from the storage device 3 and makes a comparison between design information on the volume allocation to be configured on the storage device 3 inputted by the storage manager and the gathered configuration information on the volume allocation so as to identify changes.

The present application is based on and claims priority of Japanese patent application No. 2006-119069 filed on Apr. 24, 2006, the entire contents of which are hereby incorporated by reference.

### BACKGROUND OF THE INVENTION

1. Field of the Invention

The present invention relates to a computer system, a management computer, a storage device and a volume allocation confirmation method, and in particular, to a method for confirming volume allocation of the storage device.

2. Description of the Related Art

A storage device represented by a disk array device logically divides a storage area of a disk device in the storage device and provides it as a volume to a host computer. There is a widely diffused storage area network (SAN) for connecting such a storage device to a network and connecting the host computer to the storage device via the network to use an allocated volume. In the case of the SAN, a storage manager designs which host computer the volume provided by the storage device is usable from so as to configure and start operating the storage device according to the designed contents. In the case where it is not configured in compliance with the design due to an operational mistake of the manager as to this configuration of the storage device, the host computer is put in a state of being unable to use a required volume or in a state of being able to use a volume to be allocated to another host computer. For this reason, there is a problem that data destruction in the volume occurs.

Japanese Patent Laid-Open No. 2005-18159 describes a method of creating configuration information on the storage device from a created system configuration diagram and auto-configuring the configuration information as-is on the storage device. It is possible to configure it as designed by this method so as to prevent misconfiguration of the storage device and avoid the problem.

If a computer system or a network system becomes large-scale, its operation is shared by multiple managers in order to alleviate a burden of the manager. In such a case, it is generally operated by a manager for controlling the entire system (hereafter, general manager) and a manager for partially controlling the system (hereafter, partial manager).

In the case where the SAN becomes large-scale, it also becomes difficult to have it designed, constructed and managed by one manager. For this reason, it is operated by assigning a manager of the entire SAN (hereafter, general manager), a manager per storage device connected to the SAN (hereafter, partial manager) and a manager per logical division of one storage device logically divided (hereafter, partial manager) The general manager conveys an operational policy of the entire SAN to the partial manager. The partial manager designs volume allocation in the storage device in compliance with the policy in the range of the partial manager's management, and starts the operation after configuring it per designed contents. Even in such an operational form, it is possible to automate the configuration and thereby prevent a configuration mistake.

There is a possibility, however, that the contents designed by the partial manager may be different from the operational policy conveyed by the general manager. There is also a possibility that a design mistake may simply occur. For this reason, there is a problem that a configuration different from the operational policy of the SAN may be performed even if the configuration of the storage device is automated by the method of Japanese Patent Laid-Open No. 2005-18159 or the like. There is also a problem that unintended volume allocation is performed by a design mistake and the data destruction occurs.

### SUMMARY OF THE INVENTION

To solve the problem, the present invention is a computer system comprising: at least one host computer; at least one storage device for providing at least one volume to the host computer via at least one network; and a management computer connected to the storage device via the network, wherein when a storage manager configures volume allocation of the storage device, the management computer gathers configuration information on the volume allocation of the storage device and makes a comparison between design information on the volume allocation to be configured on the storage device inputted by the storage manager and the gathered configuration information on the volume allocation so as to identify changes.

A volume allocation confirmation method of the present invention notifies a general manager of the volume allocation designed by a partial manager and configures it on the storage device after the general manager confirms that there is no problem in the contents notified. Therefore, no configuration different from an operational policy of the system will be performed. It also has effects of avoiding unintended volume allocation due to a design mistake and preventing data destruction. It also has the effect that a problem of the design discovered by the general manager is notified to the partial manager so that the partial manager can promptly correct the design contents.

### BRIEF DESCRIPTION OF THE DRAWINGS

FIG. 1 is a diagram simply showing an example of a system configuration of a computer system of first and third embodiments to which a volume allocation changing method of the present invention is applied;

FIG. 2 is a diagram simply showing a configuration of a storage device;

FIG. 3 is a diagram showing a form of a volume allocation table;

FIG. 4 is a diagram simply showing a configuration of a management computer;

FIG. 5 is a diagram showing an example of a form of a volume allocation design table;

FIG. 6 is a diagram showing an example of a form of a storage setting information table;

FIG. 7 is a diagram showing an example of a form of a storage management table;

FIG. 8 is a diagram showing an example of a form of a storage manager information table;

FIG. 9 is a diagram simply showing a configuration of a management terminal;

FIG. 10 shows a processing flow in which a volume allocation confirmation program identifies volume allocation changes and sends it to the management terminal;

FIG. 11 shows a processing flow in which the volume allocation confirmation program identifies the volume allocation changes;

FIG. 12 shows a processing flow in which the volume allocation confirmation program identifies an added volume and a deleted volume;

FIG. 13 is a diagram showing a processing flow in which the volume allocation confirmation program sends the volume allocation changes to the management terminal;

FIG. 14 is a diagram showing a processing flow of a confirm changes program;

FIG. 15 is a diagram showing a processing flow of the volume allocation confirmation program on receiving a result of confirmation of the changes from the management terminal;

FIG. 16 show examples of command formats for communicating between the confirm changes programs;

FIG. 17 is a diagram showing an example of a format of a volume addition confirmation screen;

FIG. 18 is a diagram showing an example of a format of a volume deletion confirmation screen;

FIG. 19 is a diagram showing an example of a format of a changes confirmation screen;

FIG. 20 is a diagram simply showing a configuration of the computer system of a second embodiment to which the volume allocation changing method of the present invention is applied;

FIG. 21 is a diagram simply showing a configuration of the storage device according to the second embodiment;

FIG. 22 shows a processing flow of the volume allocation confirmation program according to the second embodiment;

FIG. 23 is a diagram simply showing a configuration of the management computer according to a third embodiment;

FIG. 24 is a diagram simply showing a configuration of the management terminal according to the third embodiment;

FIG. 25 shows a processing flow in which the volume allocation confirmation program sends the volume allocation changes to a general manager according to the third embodiment; and

FIG. 26 is a diagram showing a processing flow of the confirm changes program according to the third embodiment.

### DETAILED DESCRIPTION OF THE PREFERRED EMBODIMENTS

Preferred embodiments of the present invention will be described.

Hereunder, the embodiments of a computer system, a management computer, a storage device and a volume allocation confirmation method of the present invention will be described by using the drawings.

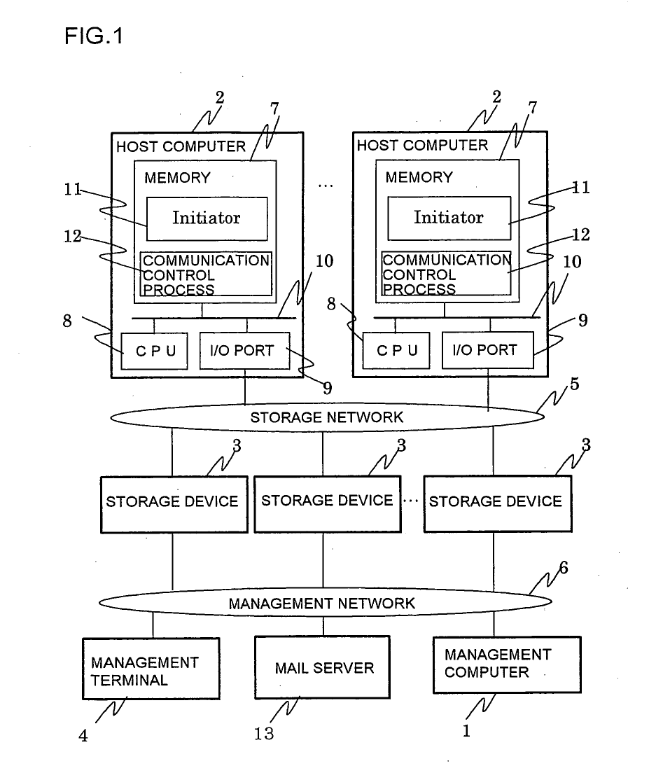

A first embodiment will be described. FIG. 1 is an example of a system configuration simply representing a computer system to which the first embodiment of the present invention is applied. As shown in FIG. 1, the computer system of this embodiment includes at least one host computer 2, at least one storage device 3 to be connected via the host computer 2 and a storage network 4, a management computer 1 connected to the storage device 3 via a management network 6 such as an IP network, a management terminal connected to the management network 6 and used by a general manager and a mail server 13 connected to the management network 6. Here, the storage network 4 and management network 6 may be one network. The storage devices 3 may be either separate devices as shown in FIG. 1 or logical storage devices having one storage device logically divided. The storage device 3 may act as the management computer 1.

The host computer 2 accesses a volume provided by the storage device 3 via the storage network 4. The host computer 2 includes a memory 7, a CPU 8, an I/O port 9 for connecting to the storage network 4, and a bus 10 for connecting these 7 to 9. The memory 7 has a communication control program 12 for communicating by using a communication protocol of the storage network and an initiator 11 for controlling access to the storage device 3 stored therein. The memory 7 also has an operating system and an application for accessing data stored in a host storage device stored therein. The CPU 8 executes these programs and accesses the volume provided by the storage device 3.

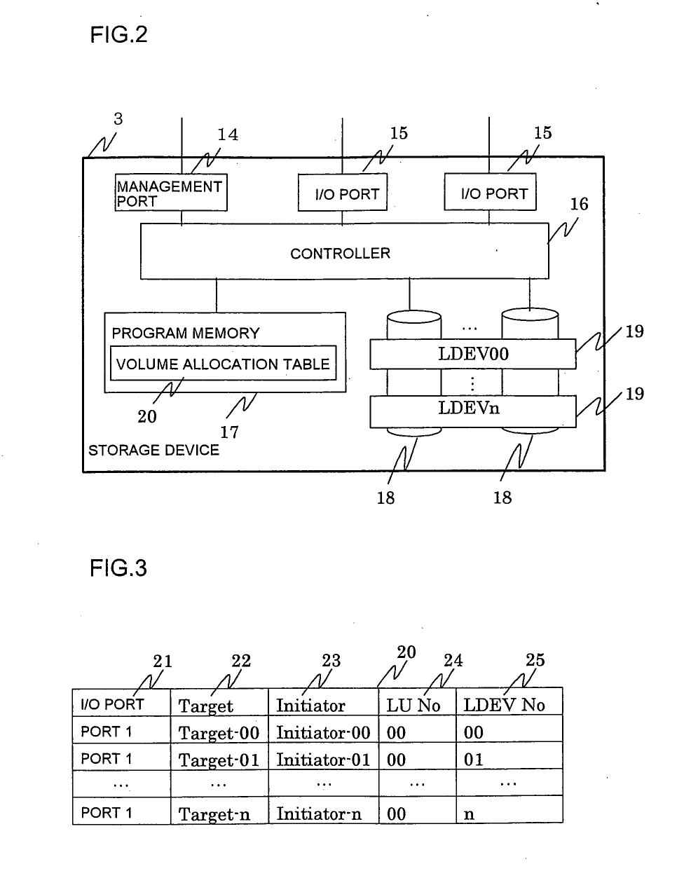

FIG. 2 is a schematic view of the storage device 3. As shown in FIG. 2, the storage device 3 includes a management port 14 for connecting to the management network 6, at least one I/O port 15 for connecting to the storage network 4, a controller 16 for exerting control in the storage device, a program memory 17 used by the controller 16 and at least one disk device 18 for configuring at least one volume 19. The program memory 17 has a volume allocation table 20 for holding an allocation state of the volume 19 stored therein.

FIG. 3 is a diagram showing examples of registrations with the volume allocation table 20. As shown in FIG. 3, the volume allocation table 20 comprises a field 21 for registering the I/O port 15 of the storage device 3 used to access the volume 19, a field 22 for registering a target of the storage device 3 for allocating the volume, a field 23 for registering the initiator of the host computer 2 connectable to the target, a field 24 for registering a logical unit number (hereafter, LU No.) of the volume notified to the initiator by the target and a field 25 for registering a logical device number (hereafter, LDEV No.) for identifying the volume. For instance, it is understandable that the volume of which LDEV No. is “00” is allocated as LU No. “00” to a “target-00” connectable from the host computer 2 having an “initiator-00” operating thereon, and the I/O port 15 of the storage device 3 for the “initiator-00” to use this volume is a “port 1.”

The controller 16 of the storage device 3 controls the access to the volume according to the contents of the volume allocation table 20.

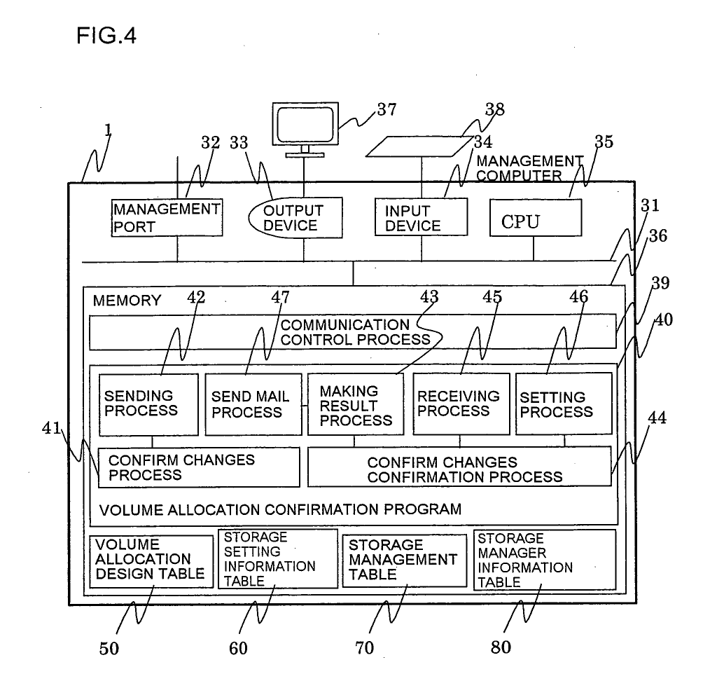

FIG. 4 is a schematic view of the management computer 1. As shown in FIG. 4, the management computer 1 is configured by a management port 32 for connecting to the management network, an output device 33 for outputting various kinds of information to a display 37, an input device 34 for processing input information from a keyboard 38 and the like, a CPU 35, a memory 36 used by the CPU 35, and a bus 31 for connecting these 32 to 36.

The memory 36 includes an operating system though not shown, a communication control program 39 for exerting communication control by using the communication protocol of the management network 6, a volume allocation confirmation program 40 for performing a volume allocation changing method of this embodiment, a volume allocation design table 50, a storage setting information table 60, a storage management table 70 and a storage manager information table 80.

The volume allocation confirmation program 40 performs the volume allocation changing method of this embodiment by a confirm changes process 41, a sending process 42, a receiving process 43, a confirm changes confirmation process 44, a receiving process 45, a setting process 46 and a send mail process 47.

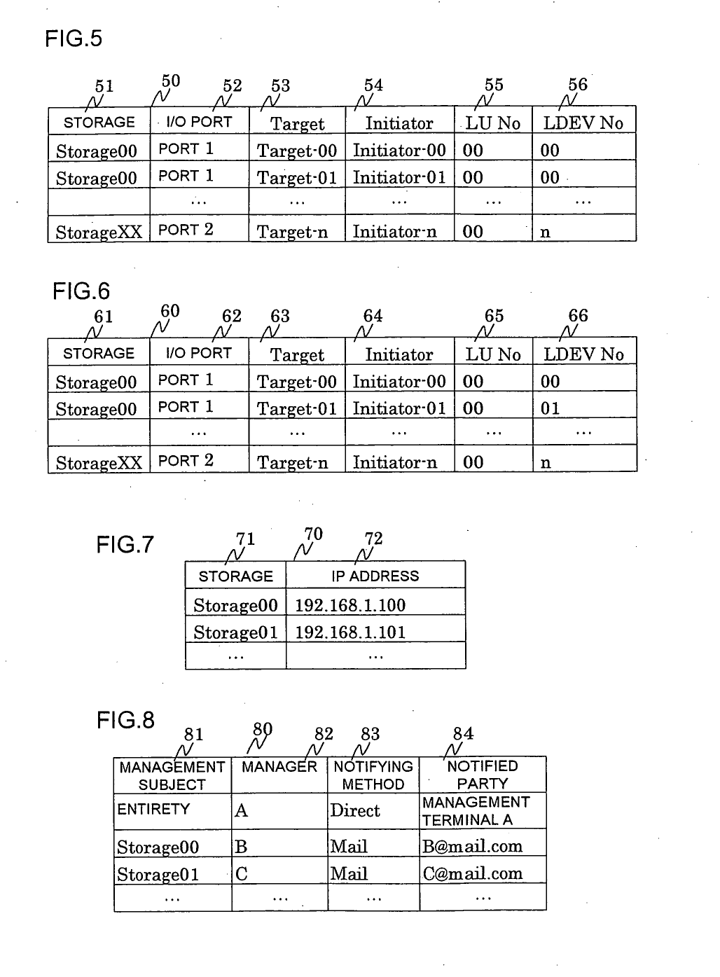

FIG. 5 is a diagram showing examples of registrations with the volume allocation design table 50. As shown in FIG. 5, the volume allocation design table 50 has entries provided to each of the allocation units of a designed volume. Each of the entries comprises a field 51 for registering information for identifying the storage device 3 as a design subject, a field 52 for registering the I/O port 15 of the storage device 3 used to access the volume 19 as a subject of the entry, a field 53 for registering a target in the storage device 3 for allocating the volume 19 as a subject of the entry, a field 54 for registering the initiator operating on the host computer 2 connectable to the target of the entry, a field 55 for registering the LU No. of the volume 19 notified to the initiator by the target and a field 56 for registering the LDEV No. for identifying the volume. For instance, as is understandable, the design is performed so that the volume of a storage device “storage00” of which LDEV No. is “00” is allocated as LU No. “00” to the targets “target-00” and “target-01” to which the initiators “initiator-00” and “initiator-01” are connectable from the I/O port 15 “port 1.”

FIG. 6 is a diagram showing examples of registrations with the storage setting information table 60. As shown in FIG. 6, the storage setting information table 60 has the entries provided to each of the volume allocation units configured on the storage device 3. Each of the entries comprises a field 61 for registering information for identifying the storage device 3 having the volume allocation indicated by the entry configured thereon, a field 62 for registering the I/O port 15 of the storage device 3 used to access the volume 19 as a subject of the entry, a field 63 for registering a target in the storage device 3 for allocating the volume 19 as a subject of the entry, a field 64 for registering the initiator operating on the host computer 2 connectable to the target of the entry, a field 65 for registering the LU No. of the volume 19 notified to the initiator by the target and a field 66 for registering the LDEV No. for identifying the volume. For instance, it is understandable that the volume of a storage device “storage00” of which LDEV No. is “00” is allocated as LU No. “00” to the target “target-00” to which the initiator “initiator-00” is connectable from the I/O port 15 “port 1.”

FIG. 7 is a diagram showing examples of registrations with the storage management table 70. As shown in FIG. 7, the storage management table 70 has the entries provided to each of the storage devices 3. Each of the entries comprises a field 71 for registering information for identifying the storage device 3 as the subject of the entry, a field 72 for registering an IP address set on the management port 14 of the storage device 3. For instance, it is understandable that the IP address set on the management port 14 of the storage device “storage00” is “192. 168. 1. 100.”

FIG. 8 is a diagram showing examples of registrations with the storage manager information table 80. As shown in FIG. 8, the storage manager information table 80 has the entries provided to each of management subjects. Each of the entries comprises a field 81 for registering the management subject, a field 82 for registering a name of the manager for managing the management subject, a field 83 for registering a method of notifying the manager and a field 84 for registering a notified party of the manager. For instance, it is understandable that the manager of the storage device “storage00” is “B, the method of notifying a manager “B” is “e-mail” and the notified party is “B@mail.com.” It is understandable that the entry of which management subject is “entirety” indicates being the general manager and a manager “A” is the general manager in FIG. 8.

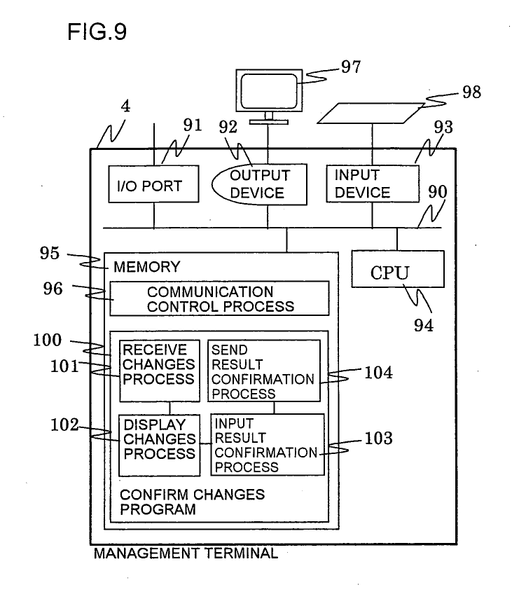

FIG. 9 is a schematic view of a management terminal 4. As shown in FIG. 9, the management terminal 4 is configured by an I/O port 91 for connecting to the management network 6, an output device 92 for outputting various kinds of information to a display 97, an input device 93 for processing input information from a keyboard 98 and the like, a CPU 94, a memory 95 used by the CPU 94, and a bus 90 for connecting these 91 to 95.

The memory 95 includes an operating system (not shown), a communication control program 96 for exerting communication control by using the communication protocol of the management network 6 and a confirm changes program 100 for performing the volume allocation changing method of this embodiment. The confirm changes program 100 performs the volume allocation changing method of this embodiment by a receive changes process 101, a display changes process 102, an input result confirmation process 103 and a send result confirmation process 104.

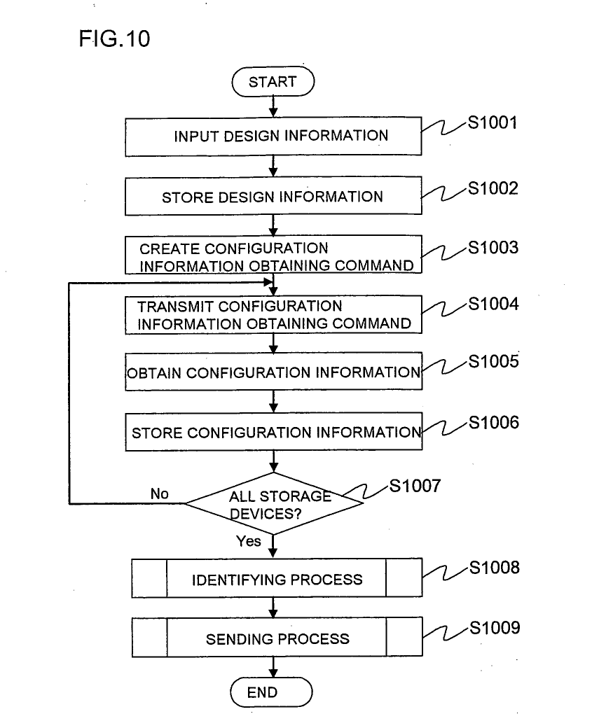

Next, a description will be given by using FIGS. 10 to 19 as to procedures of the volume allocation confirmation program 40 and the confirm changes program 100 for realizing the volume allocation confirmation method of this embodiment.

FIG. 10 shows a processing flow in which the volume allocation confirmation program 40 confirms the changing volume allocation. The volume allocation confirmation program 40 operates when the partial manager inputs design information on the volume allocation. The design information may be inputted from the keyboard 38 or the like via the input device 34, or an external storage device may be connected to the management computer 1.

First, the confirm changes process 41 starts, and the design information on the volume allocation designed by the partial manager is inputted (S1001) to be stored in the volume allocation design table 50 (S1002). Next, a configuration information obtaining command is created (S1003). Next, the IP address 72 of the management port 14 of the storage device 3 is obtained by referring to the storage management table 70 and so as to transmit the configuration information obtaining command to the IP address (S1004). The volume allocation configured on the storage device 3 is obtained from the storage device 3 (S1005), and the obtained configuration information is stored in the storage setting information table 60 (S1006). Next, it is checked whether or not the configuration information obtaining command is transmitted to all the storage devices 3 registered with the storage management table 70 (S1007). If not transmitted, it moves on to the step S1004 to transmit the configuration information obtaining command to a next storage device 3. In the case where, as a result of the step S1007, the configuration information obtaining command has been completely transmitted to all the storage devices 3, it moves on to the step S1008. A changes identification process is performed, where a comparison is made between the volume allocation design table 50 and the storage setting information table 60 so as to identify the volume allocation changed by the design of the partial manager (S1008). Details of the changes identification process will be described later. Next, the changes identified in the step S1008 is notified to the general manager as the sending process 42 (S1009) to finish the processing.

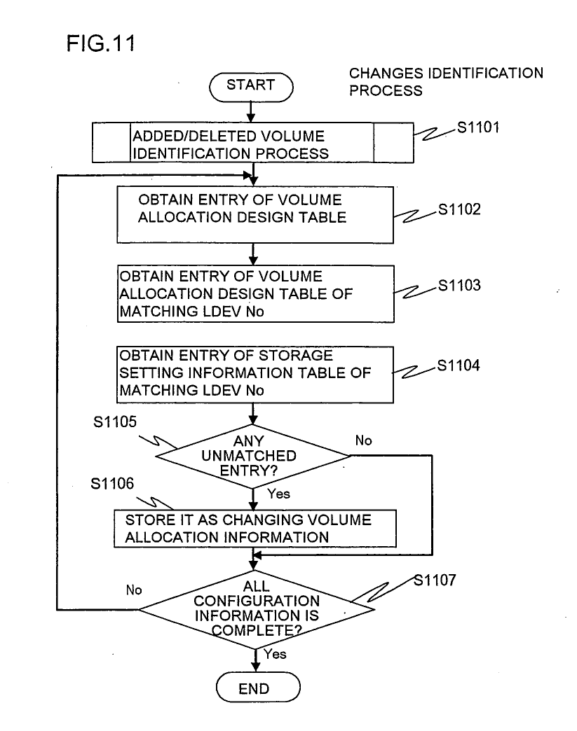

Next, the changes identification process of the step S1008 in FIG. 10 will be described by using FIG. 11. First, it is checked whether a new volume is added or an existing volume is deleted (S1101). Details of this process will be described later. Next, an entry of the volume allocation design table 50 is obtained (S1102), and all the entries of the volume allocation design table 50 matching with the values of the fields 51 and 56 of the obtained entry respectively are obtained (S1103). To be more specific, those obtained are all the entries indicating the design of the allocation of the volume 19 on the storage device 3 which is the same as the entry obtained in the step S1102. Next, as in the step S1103, all the entries are obtained from the storage setting information table 60, in which the value of the field 61 matches with the value of the field 51 of the entry obtained in the step S1102 and the value of the field 66 matches with the value of the field 56 of the entry obtained in the step S1102 (S1103). To be more specific, those obtained are the entries of the storage setting information table 60 indicating the configuration of the allocation of the volume 19 on the storage device 3 which is the same as the entry obtained in the step S1102 (S1104). Next, a comparison is made between the entries of the volume allocation design table 50 obtained in the step S1103 and the entries of the storage setting information table 60 obtained in the step S1104 so as to determine whether or not there are any unmatched entries among all the entries (S1105). Consequently, it moves on to a step S1107 in the case where all the entries are matching. If there are any unmatched entries, it moves on to a step S1107 after storing the entries of the volume allocation design table 50 obtained in the step S1103 and the entries of the storage setting information table 60 obtained in the step S1104 as changing volume allocation information (S1106). It is checked whether or not the processing is completed as to all the entries of the volume allocation design table 50 (S1107). It moves on to the step S1102 if not completed. If completed, it finishes the processing and moves on to the step S1009 of FIG. 10.

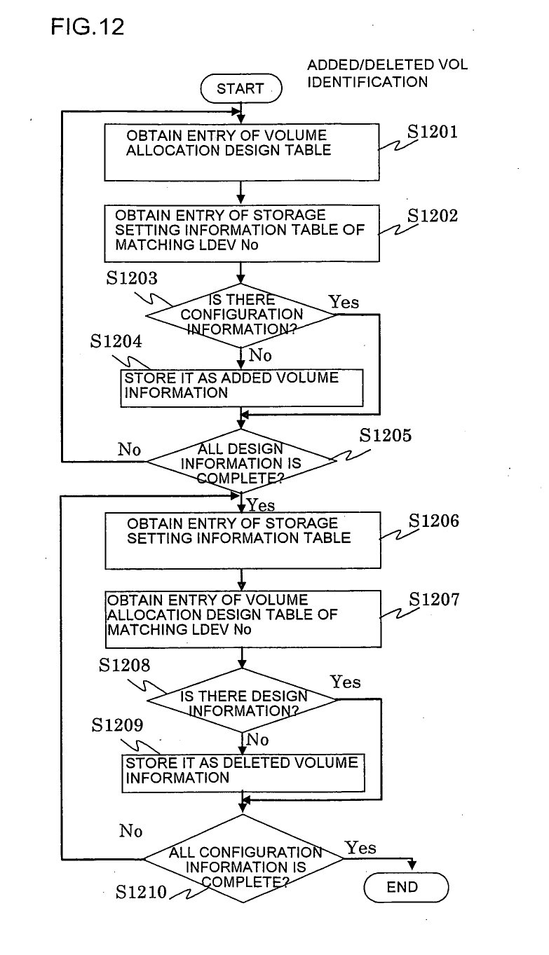

FIG. 12 shows a detailed processing flow of the added/deleted volume identification process of the step S1101 of FIG. 11. In this processing, an entry of the volume allocation design table 50 is obtained (S1201), and all the entries are obtained from the storage setting information table 60, in which the value of the field 61 matches with the value of the field 51 of the entry obtained in the step S1201 and the value of the field 66 matches with the value of the field 56 of the entry obtained in the step S1201 (S1202). To be more specific, those obtained are the entries of the storage setting information table 60 indicating the configuration of the allocation of the volume 19 on the storage device 3 which is the same as the entry obtained in the step S1201. Next, it is checked whether or not the entries of the storage setting information table 60 are obtained in the step S1202 (S1203). It moves on to a step S1205 in the case where the entries are obtained. If no entry is obtained, it moves on to the step S1205 after storing the entry of the volume allocation design table 50 obtained in the step S1201 as added volume information (S1204). It is checked whether or not the processing is completed as to all the entries of the volume allocation design table 50 (S1205). If not completed, it moves on to the step S1201 and obtains a next entry to repeat the processing. If completed, it moves on to a step S1206. It is possible, by performing the processing of the steps S1201 to S1205, to identify the design information on the volume to be newly added.

Next, an entry of the storage setting information table 60 is obtained (S1206). Next, all the entries are obtained from the volume allocation design table 50, in which the value of the field 51 matches with the value of the field 61 of the entry obtained in the step S1206 and the value of the field 56 matches with the value of the field 66 of the entry obtained in the step S1206 (S1207). To be more specific, those obtained are the entries of the storage setting information table 60 for the storage device 3 and the volume 19 indicated by the entry obtained in the step S1206. Next, it is checked whether or not the entries of the volume allocation design table 50 are obtained (there is detailed information) in the step S1207 (S1208). It moves on to a step S1210 in the case where the entries are obtained. If no entry is obtained, it moves on to the step S1210 after storing the entry of the storage setting information table 60 obtained in the step S1206 as deleted volume information (S1209). It is checked whether or not the processing is completed as to all the entries of the storage setting information table 60 (S1210). If not completed, it moves on to the step S1206 and obtains a next entry to repeat the processing. If completed, it finishes the processing and moves on to a step S1102 of FIG. 11. It is possible, by performing the processing of the step S1206 to S1210, to identify the volume 19 to be deleted.

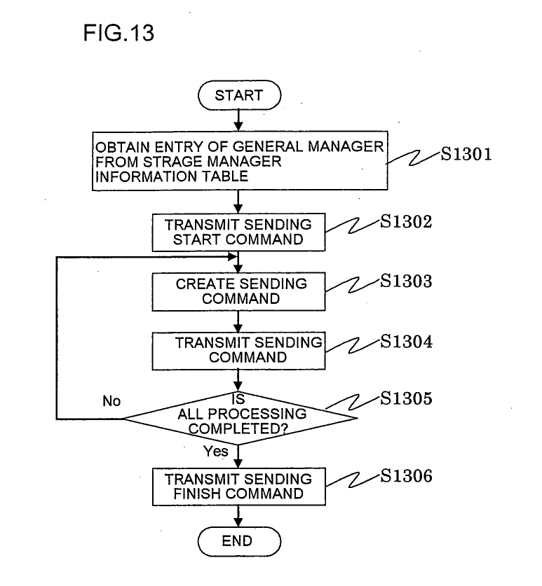

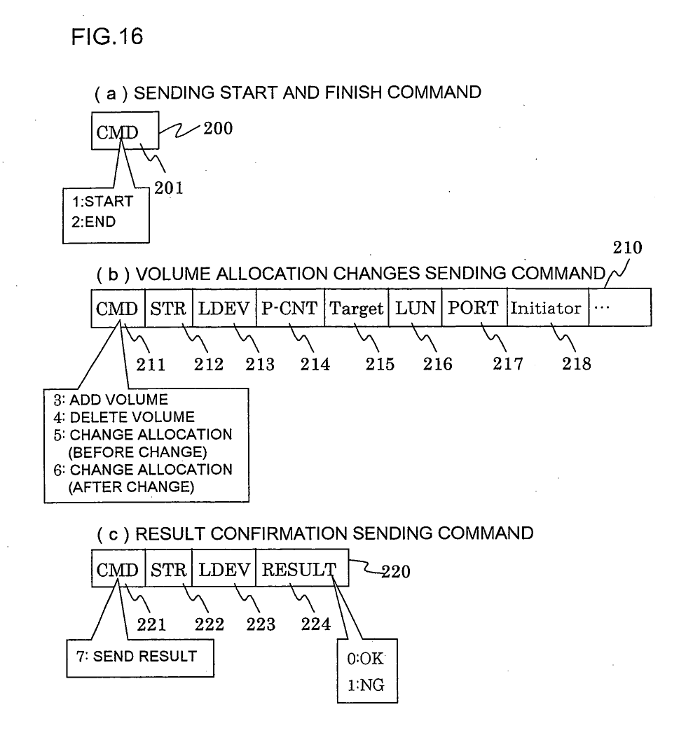

Next, the sending process of the step S1009 of FIG. 10 will be described by using FIG. 13. FIG. 13 shows a processing flow in which the identified volume allocation changes is sent to the management terminal 4 used by the general manager by the volume allocation confirmation program 40. First, the entry indicating the information on the general manager is obtained from the storage manager information table 80 (S1301). The entry in which the value of the field 81 indicating the management subject of the storage manager information table 80 is the “entirety” is the entry of the general manager. The field 81 of the first entry of FIG. 8 is the “entirety” and is the entry indicating the information on the general manager as is understandable. Next, a sending start command is transmitted to the notified party indicated in the field 84 of the entry obtained in the step S1301 (S1302). The value of the field 84 of the first entry of FIG. 8 is a “manager terminal A,” and the sending start command is transmitted to the manager terminal A. FIG. 16A shows an example of the form of a sending start and finish command 200. As shown in FIG. 16A, the sending start and finish command 200 is configured only by a field 201, where the sending start command becomes a sending start command or a sending finish command depending on the value of the field 201. It is the sending start command in the case where the value of the field 201 is “1” while it is the sending finish command in the case of “2.”

Next, a volume allocation changes sending command 210 is created (S1303). FIG. 16B shows an example of the form of the volume allocation changes sending command 210. The volume allocation changes sending command 210 is configured by a field 211 for indicating the contents notified, a field 212 for indicating the storage device 3 of which allocated volume 19 is changed, a field 213 for indicating the volume 19 of which allocation is changed, a field 215 for indicating a target for allocating the volume of which allocation is changed, a field 216 for indicating the LU No. allocated to the volume in the target indicated by the field 215, a field 217 for indicating the I/O port of the storage device 3 connectable to the target indicated by the field 215, a field 218 for indicating the initiator 11 of the host computer 2 connectable to the target indicated by the field 215, and a field 214 for indicating the number of sets by rendering the fields 215 to 218 as a set. The fields 215 to 218 are repeated by the number of sets indicated by the field 214. The field 211 changes its value according to the volume allocation changes.

In the case where the value of the field 211 is “3,” it indicates that the volume 19 is newly added, and the values of the fields 212 to 218 are the information on the newly added volume 19. Specifically, the value of the field 51 of the entry of the volume allocation design table 50 stored as added volume information in the step S1204 of FIG. 12 is set in the field 212, the value of the field 56 is set in the field 213, the value of the field 53 is set in the field 215, the value of the field 55 is set in the field 216, the value of the field 52 is set in the field 217, and the value of the field 54 is set in the field 218 respectively.

In the case where the value of the field 211 is “4,” it indicates that the volume is deleted, and the values of the fields 212 to 218 are the information on the deleted volume 19. Specifically, the value of the field 61 of the entry of the storage setting information table 60 stored as deleted volume information in the step S1209 of FIG. 12 is set in the field 212, the value of the field 66 is set in the field 213, the value of the field 63 is set in the field 215, the value of the field 65 is set in the field 216, the value of the field 62 is set in the field 217, and the value of the field 64 is set in the field 218 respectively.

In the case where the value of the field 211 is “5,” it indicates that the allocation of the volume 19 is changed, and the values of the fields 212 to 218 are pre-change information on the volume 19 to have its allocation changed, that is, existing configuration information. Specifically, the value of the field 61 of the entry of the storage setting information table 60 stored as the changing volume allocation information in the step S1106 of FIG. 11 is set in the field 212, the value of the field 66 is set in the field 213, the value of the field 63 is set in the field 215, the value of the field 65 is set in the field 216, the value of the field 62 is set in the field 217, and the value of the field 64 is set in the field 218 respectively.

In the case where the value of the field 211 is “6,” it indicates that the allocation of the volume 19 is changed, and the values of the fields 212 to 218 are post-change information on the volume 19 to have its allocation changed, that is, the design information. Specifically, the value of the field 51 of the entry of the volume allocation design table 50 stored as the changing volume allocation information in the step S1106 of FIG. 11 is set in the field 212, the value of the field 56 is set in the field 213, the value of the field 53 is set in the field 215, the value of the field 55 is set in the field 216, the value of the field 52 is set in the field 217, and the value of the field 54 is set in the field 218 respectively.

In FIG. 13, the volume allocation changes sending command 210 having the field 211 of “3” or “4” is created next for each of the volumes added or deleted (S1303). On changing the volume allocation, the command having the field 211 of “5” or “6” is created one by one for the volume to have its allocation changed. Next, the volume allocation changes sending command 210 created in the step S1303 is transmitted to the notified party indicated by the field 84 of the entry obtained in the step S1301 (S1304). And it is checked whether or not the processing is completed as to all of the information stored as the changing volume allocation information in the step S1106 of FIG. 11, the information stored as the added volume information in the step S1204 of FIG. 12 and the information stored as the deleted volume information in the step S1209 of FIG. 12 (S1305). If not completed, it moves on to the step S1303 and repeats the processing. If completed, it transmits the sending finish command having set the value of the field 201 of the sending start and finish command of FIG. 16A to “2” to the notified party indicated by the field 84 of the entry obtained in the step S1301 (S1306) so as to finish the processing.

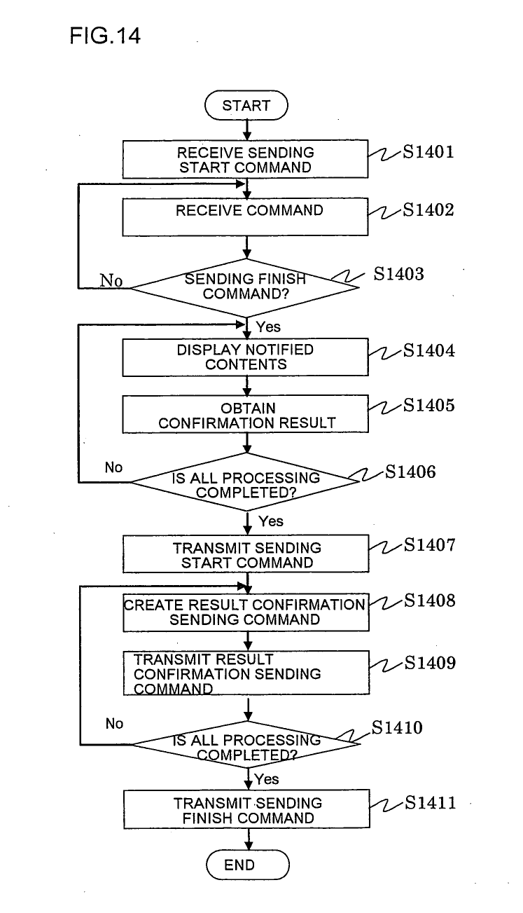

FIG. 14 shows a processing flow of the confirm changes program 100 of the management terminal 4. The processing is started by the confirm changes program 100 upon receiving the sending start command sent from the volume allocation confirmation program 40. First, the receive changes process 101 receives a sending command from the confirm changes program 100 (S1401). Next, it receives a command transmitted from the volume allocation confirmation program 40 (S1402) and determines whether or not the command received in the step S1402 is the sending finish command (S1403). In the case of the sending finish command as a result of the step S1403, it moves on to a step S1404. In the case where the command is not the sending finish command, that is, in the case of the volume allocation changes sending command 210, it moves on to the step S1402 to receive the next command from the volume allocation confirmation program 40. The processing so far completes reception of all the volume allocation changes sending commands 210 transmitted by the volume allocation confirmation program 40.

After the reception of the commands from the volume allocation confirmation program 40 is completed by the confirm changes program 100, the display changes process 102 displays the contents notified for each of the volume allocation changes sending commands 210 on the display 97 (S1404). In this case, the contents to be displayed are different according to the contents of the volume allocation changes sending command 210.

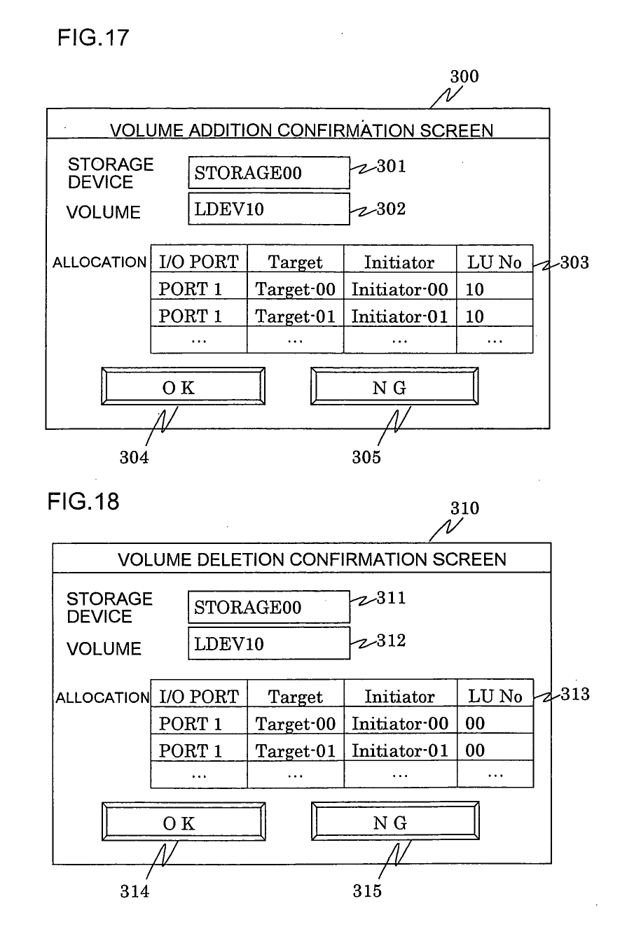

In the case where the value of the field 211 of the volume allocation changes sending command 210 is “3,” that is, in the case where the volume 19 is newly added, a volume addition confirmation screen 300 is displayed. FIG. 17 is a diagram showing an example of the volume addition confirmation screen 300. The volume addition confirmation screen 300 is configured by a field 301 for displaying the information for identifying the storage device 3 to which the volume 19 is added, a field 302 for displaying the information for identifying the added volume, a field 303 for displaying the information for identifying the target of the storage device 3 to which the added volume 19 is allocated, the information for identifying the initiator of the host computer 2 connectable to the target, the LU No. of the volume 19 notified to the initiator by the target and the I/O port 15 of the storage device 3 for connecting the initiator to the target, an OK button 304 and an NG button 305. The general manager selects the OK button 304 in the case of permitting the addition of the volume 19 by referring to the contents displayed on the volume addition confirmation screen 300, and selects the NG button 305 in the case of not permitting the addition of the volume 19.

In the case where the value of the field 211 of the volume allocation changes sending command 210 is “4,” that is, in the case where the volume 19 is deleted, a volume deletion confirmation screen 310 is displayed. FIG. 18 is a diagram showing an example of the volume deletion confirmation screen 310. The volume deletion confirmation screen 310 is configured by a field 311 for displaying the information for identifying the storage device 3 from which the volume 19 is deleted, a field 312 for displaying the information for identifying the deleted volume, a field 313 for displaying the information for identifying the target of the storage device 3 to which the deleted volume 19 is allocated, the information for identifying the initiator of the host computer 2 connectable to the target, the LU No. of the volume 19 notified to the initiator by the target and the I/O port 15 of the storage device 3 for connecting the initiator to the target, an OK button 314 and an NG button 315. The general manager selects the OK button 314 in the case of permitting the deletion of the volume 19 by referring to the contents displayed on the volume deletion confirmation screen 310, and selects the NG button 315 in the case of not permitting the deletion of the volume 19.

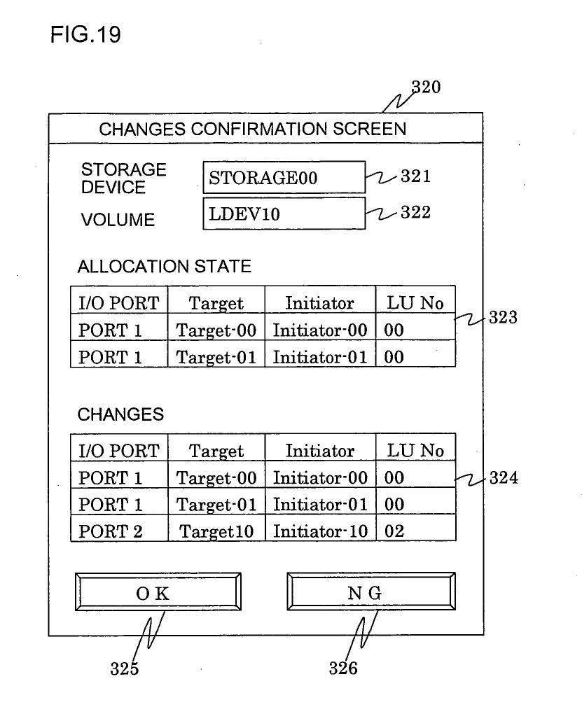

In the case where the value of the field 211 of the volume allocation changes sending command 210 is “5,” that is, in the case where the allocation of the volume 19 is changed, a changes confirmation screen 320 is displayed. FIG. 19 is a diagram showing an example of the changes confirmation screen 320. The changes confirmation screen 320 is configured by a field 321 for displaying the information for identifying the storage device 3 of which allocation of the volume 19 is changed, a field 322 for displaying the information for identifying the volume of which allocation is changed, a field 323 for displaying the information for identifying the target of the storage device 3 to which the volume 19 before changing the allocation is allocated, the information for identifying the initiator of the host computer 2 connectable to the target, the LU No. of the volume 19 notified to the initiator by the target and the I/O port 15 of the storage device 3 for connecting the initiator to the target, a field 324 for displaying the information for identifying the target of the storage device 3 to which the volume 19 for having its allocation changed is allocated after changing the allocation, the information for identifying the initiator of the host computer 2 connectable to the target, the LU No. of the volume 19 notified to the initiator by the target and the I/O port 15 of the storage device 3 for connecting the initiator to the target, an OK button 325 and an NG button 326. The field 323 displays the contents of the volume allocation changes sending command 210 of which value of the field 211 is “5,” and the field 324 displays the contents of the volume allocation changes sending command 210 of which value of the field 211 is “6.” The general manager selects the OK button 325 in the case of permitting the change of allocation of the volume 19 by referring to the contents displayed on the changes confirmation screen 320, and selects the NG button 326 in the case of not permitting the change of allocation of the volume 19.

In FIG. 14, the button selected by the general manager on the screen displayed in the step S1404 is obtained through the input result confirmation process 103 by the confirm changes program 100. Next, it is checked whether or not the processing of the steps S1404 and S1405 is completed as to all the volume allocation changes sending commands 210 received in the processing of the steps S1402 and S1403 (S1406). If not completed, it moves on to the step S1404 and performs the processing for the contents of the next volume allocation changes sending command 210. If completed, it moves on to a step S1407. The send result confirmation process 104 transmits to the management computer 1 the sending start command indicating a start of sending the result confirmed by the general manager obtained in the step S1405 to the management computer 1 (S1407). Next, a result confirmation sending command 220 is created (S1408). FIG. 16C is a diagram showing an example of the form of the result confirmation sending command 220. The result confirmation sending command 220 is configured by a field 221 for indicating the contents notified, a field 222 for indicating the information for identifying the storage device 3 which is the subject of the result confirmation, a field 223 for indicating the information for identifying the volume 19 which is the subject of the result confirmation and a field 224 for indicating the result confirmation. The field 221 has “7” indicating the result confirmation sending command 220 set therein. The field 222 has the information for identifying the storage device 3 set in the field 212 of the volume allocation changes sending command 210 set therein. The field 223 has the information for identifying the volume 19 set in the field 213 of the volume allocation changes sending command 210 set therein. The field 224 has “0” set therein in the case where the general manager selects the OK button on the screen displayed in the step S1404, and has “1” set therein in the case of selecting the NG button.

In FIG. 14, the result confirmation sending command created in the step S1408 is transmitted to the management computer 1 next (S1409). And it is checked whether or not sending of all the result confirmations of the general manager obtained in the steps S1404 and S1406 to the management computer 1 has been completed (S1410). If not completed, it moves on to the step S1408 and processes the next result confirmation. If completed, it moves on to the step S1411 and transmits the sending finish command to the management computer 1 (S1411) so as to finish the processing.

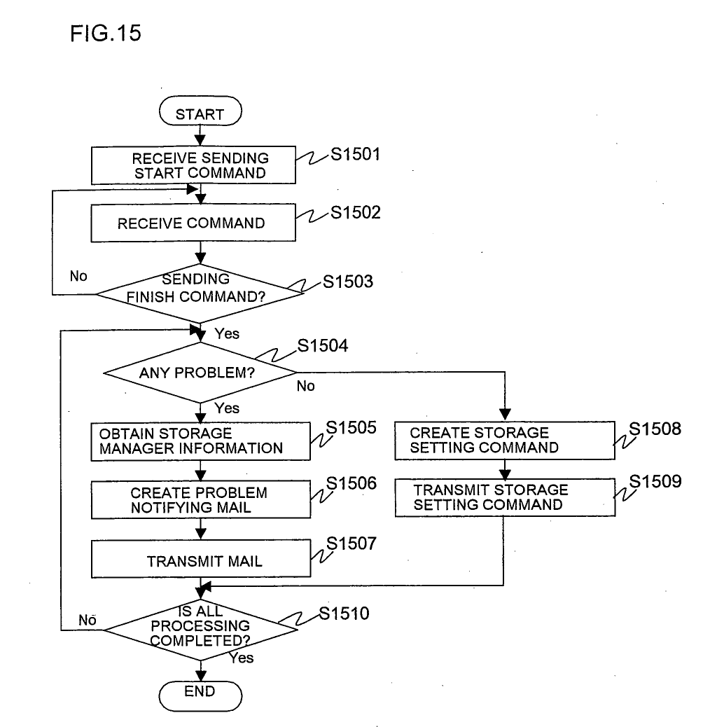

Next, a description will be given by using FIG. 15 as to the processing in the case where the result confirmation sending command 220 sent from the confirm changes program 100 of the management terminal 4 is received by the volume allocation confirmation program 40 of the management computer 1.

FIG. 15 shows a processing flow of the volume allocation confirmation program 40 on receiving the result confirmation sending command 220 from the confirm changes program 100. First, the receiving process 43 receives the sending start command transmitted by the confirm changes program 100 (S1501). Next, it receives a next command from the confirm changes program 100 (S1502) and determines whether or not the command received in the step S1502 is the sending finish command (S1503). In the case of the sending finish command as a result of the step S1503, it moves on to a step S1504. In the case where the command is not the sending finish command, that is, in the case of the result confirmation sending command 220, it moves on to the step S1502 to receive the next command transmitted by the confirm changes program 100.

Next, the confirm changes confirmation process 44 checks the value of the field 224 of the result confirmation sending command 220 received in the step S1503 (S1504). In the case where the value is “1” as a result of this check, that is, in the case where the change of allocation is not permitted, it moves on to a step S1505 implemented by a making result process 45. The information on the manager of the storage device 3 set in the field 222 of the result confirmation sending command 220 of which value of the field 224 is “1” is obtained from the storage manager information table 80 (S1505). For instance, in the case where the value of the field 222 is “storage00,” the information of the second entry in FIG. 8 is obtained. Next, the changes corresponding to the result confirmation sending command 220 are configured as mail text (S1506). Specifically, the values of the fields 51 and 55 of the volume allocation design table 50 stored as the changing volume allocation information in the step S1106 of FIG. 11 configure the values of the fields 51 to 56 of the entry of which field 222 matches with the field 222 of the result confirmation sending command as the mail text, and the values of the fields 61 and 65 of the storage setting information table 60 stored as the changing volume allocation information in the step S1106 of FIG. 11 configure the values of the fields 61 to 66 of the entry of which field 222 matches with the field 222 of the result confirmation sending command as the mail text. The values of the fields 51 and 55 of the volume allocation design table 50 stored as the added volume information in the step S1204 of FIG. 12 configure the values of the fields 51 to 56 of the entry of which the field 222 matches with the field 222 of the result confirmation sending command as the mail text. The values of the fields 61 and 65 of the storage setting information table 60 stored as the deleted volume information in the step S1209 of FIG. 12 configure the values of the fields 61 to 66 of the entry of which field 222 matches with the field 222 of the result confirmation sending command as the mail text.

In FIG. 15, the send mail process 47 transmits the mail text created in the step S1506 to the value of the field 84 of the entry of the storage manager information table obtained in the step S1505 next (S1507). For instance, in the case where the entry obtained in the step S1505 is the second entry in FIG. 9, it transmits the mail created in the step S1506 to “B@mail.com” so as to move on to the step S1510. Here, the mail server 13 as a destination of the mail needs to be connected to a network capable of communication with the management computer 1. In FIG. 1, the mail server 13 is connected to the management network 6.

In the case where the value of the field 224 of the result confirmation sending command 220 received in the step S1503 is “0” as a result of the determination in the step S1504, that is, in the case where the change of allocation is permitted, it moves on to a step S1508 implemented by the setting process 46. A setting command for the storage device 3 is created (S1508). Specifically, the values of the fields 51 and 55 of the volume allocation design table 50 stored as the changing volume allocation information in the step S1106 of FIG. 11 create a command for adding the volume 19 indicated by the entry with the values of the fields 51 to 56 of the entry of which field 222 matches with the field 222 of the result confirmation sending command. The values of the fields 51 and 55 of the volume allocation design table 50 stored as the added volume information in the step S1204 of FIG. 12 create a command for adding the volume 19 indicated by the entry with the values of the fields 51 to 56 of the entry of which field 222 matches with the field 222 of the result confirmation sending command. Furthermore, the values of the fields 61 and 65 of the storage setting information table 60 stored as the deleted volume information in the step S1209 of FIG. 12 create a command for deleting the volume 19 indicated by the entry with the values of the fields 61 to 66 of the entry of which field 222 matches with the field 222 of the result confirmation sending command.

In FIG. 15, it refers to the storage management table 70 and obtains the IP address set on the management port 14 of the storage device 3 which is set in the field 222 of the result confirmation sending command 220. It transmits the setting command for the storage device 3 created in the step S1508 to the IP address (S1509) and moves on to a step S1510.

It is checked whether or not the processing is completed as to all the result confirmation sending commands 220 received in the steps S1502 and S1503 (S1510). If not completed, it moves on to the step S1504 and performs the processing for the next result confirmation sending command 220. If completed, it finishes the processing.

According to the first embodiment of the volume allocation confirmation method of the present invention described above, a comparison is made between the volume allocation information designed by the partial manager and the information on the volume allocation configured on the storage device 3. Thus, the volume of which allocation is changed, added or deleted according to the design is identified so as to send that information to the general manager. In the case where there is no problem in the design as a result of the confirmation by the general manager, the configuration is performed on the storage device 3 according to the design. In the case where there is a problem, the partial manager is notified thereof. For this reason, the configuration of the volume allocation different from an operational policy of the computer system or the storage device is no longer performed. It is also has the effects of avoiding unintended volume allocation due to a design mistake and preventing data destruction. It also has the effect that a problem of the design discovered by the general manager is notified to the partial manager so that the partial manager can promptly correct the design contents.

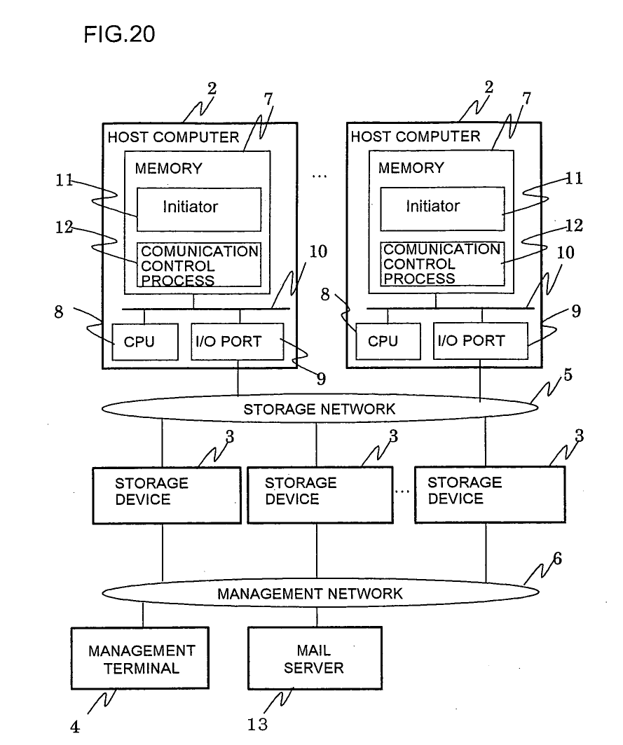

FIG. 20 is an example of a system configuration simply representing the computer system to which the second embodiment of the present invention is applied. The portions in common with the first embodiment are given the same symbols as those in the first embodiment. Unlike the first embodiment, the second embodiment has a configuration with no management computer 1. The volume allocation confirmation program 40 for operating on the management computer 1 operates on each of the storage devices 3.

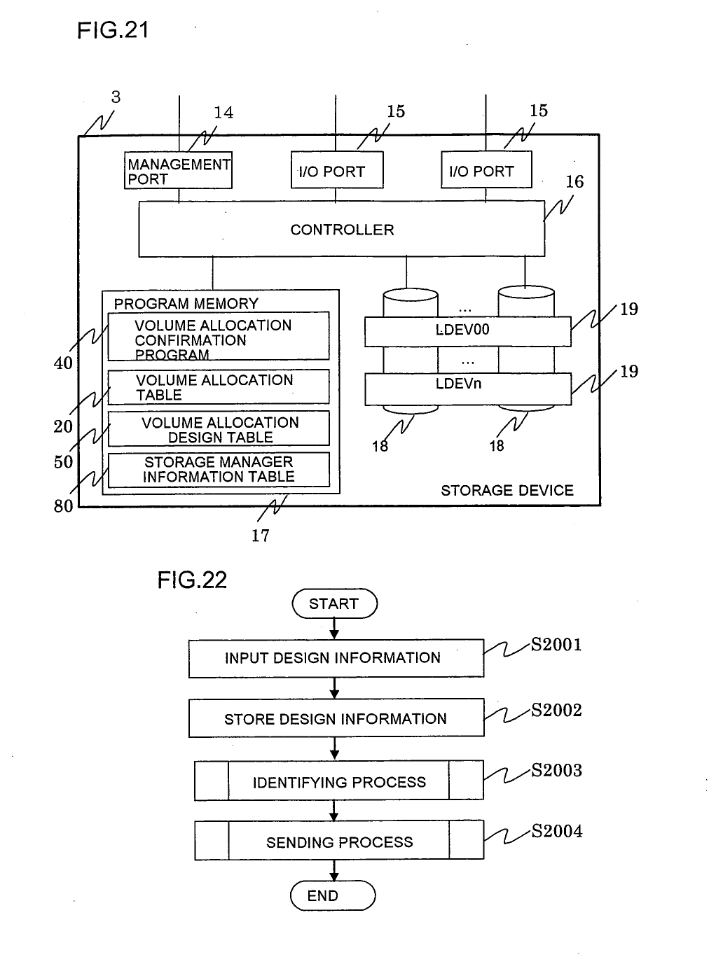

FIG. 21 is a schematic view of the storage device 3 of the second embodiment. As shown in FIG. 21, the storage device 3 of the second embodiment includes the volume allocation confirmation program 40, volume allocation design table 50 and storage manager information table 80 in the program memory 17 unlike the storage device 3 of the first embodiment. The volume allocation design table 50 and the storage manager information table 80 are the same as those of the first embodiment, and are in the forms of FIGS. 6 and 7 respectively. The configuration of the volume allocation confirmation program 40 is the same as that of the first embodiment, and is also the same configuration as that of FIG. 4 while the processing is different. The different processing will be described by using FIG. 22.

FIG. 22 shows a processing flow of the volume allocation confirmation program according to the second embodiment. First, design information on the volume allocation to be inputted by the partial manager is inputted by the confirm changes process 41 (S2001), and the design information inputted in the step S2001 is stored in the volume allocation design table 50 (S2002). Next, a comparison is made between the volume allocation design table 50 and the volume allocation table 20 to identify the contents of the change of allocation of the volume 19 (S2003). This process is the same process as the step S1008 of FIG. 10, and is performed according to processing flows of FIGS. 11 and 12. For this reason, a detailed description of this process will be omitted in the second embodiment. However, the process is performed by using the volume allocation table 20 instead of the storage setting information table 60 used in the first embodiment. After identifying the contents of the change of allocation of the volume 19 in the step S2003, the changes are sent to the general manager by the confirm changes process 41 (S2004). This process is the same process as the step S1009 of FIG. 10, and is performed according to the processing flow of FIG. 13. For this reason, a detailed description of this process will be omitted in the second embodiment.

The operation of the confirm changes program 100 operating on the management terminal 4 is the same as that of the first embodiment, and so a description thereof will be omitted. The operation of the volume allocation confirmation program 40 on receiving the result confirmation sending command 220 from the confirm changes program 100 is also the same as that of the first embodiment, and so a description thereof will be omitted.

As described above, the second embodiment of the volume allocation confirmation method of the present invention has the same effects as the first embodiment.

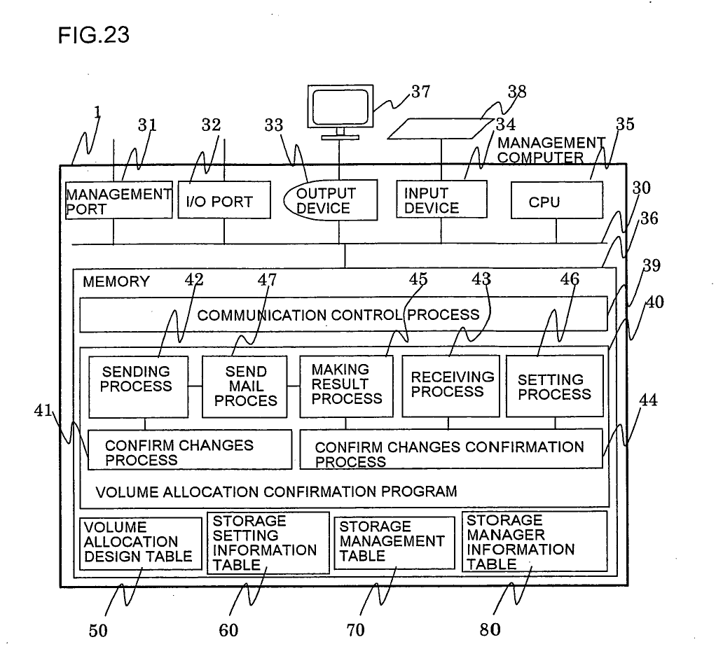

FIG. 23 is a schematic block diagram of the management computer 1 according to a third embodiment of the present invention. According to a third embodiment, the configuration of the computer system is the same as that of the first embodiment, which is the configuration of FIG. 1. As shown in FIG. 23, the parts configuring the management computer 1 of the third embodiment are the same as those of the management computer 1 of the first embodiment (FIG. 4). There is a difference between them, however, that the sending process 42 of the volume allocation confirmation program 40 is related to the send mail process 47. It is because the contents of the change of allocation of the volume 19 are sent to the general manager by mail according to the third embodiment.

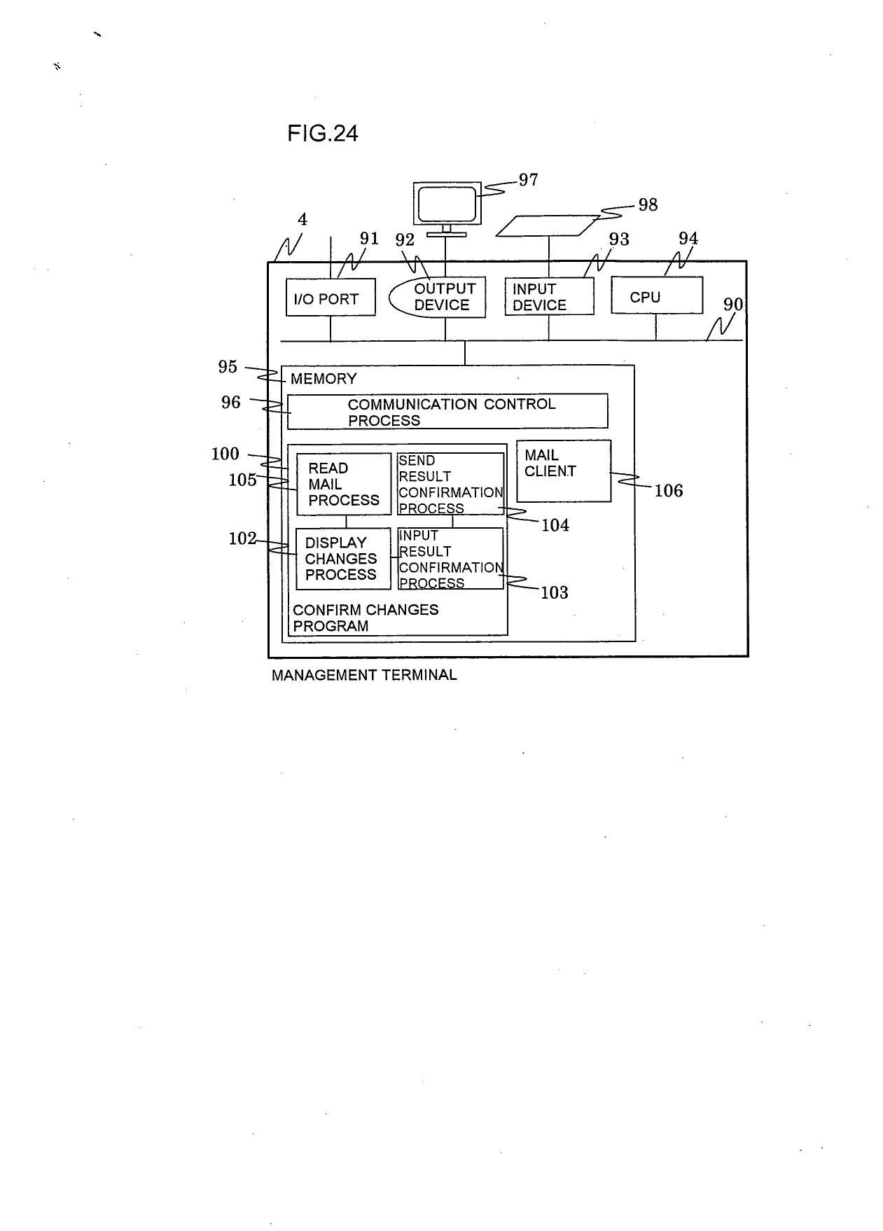

FIG. 24 is a schematic block diagram of the management terminal 4 according to the third embodiment. As shown in FIG. 24, in the third embodiment, the memory 95 includes a mail client 106 in addition to the configuration of the management terminal 4 of the first embodiment (FIG. 9). The mail client 106 operates in order to receive the mail transmitted by the volume allocation confirmation program 40 operating on the management computer 1. As for the confirm changes program 100, a read mail process 105 operates instead of the receive changes process 101 configuring the confirm changes program 100 of the first embodiment. This is the process for reading the mail indicating the contents of the change of allocation of the volume 19 received by the mail client 106 in order to handle it in the confirm changes program 100.

Next, the processing of the volume allocation confirmation program 40 in the third embodiment will be described. The processing of the volume allocation confirmation program 40 in the third embodiment is different from the first embodiment as to the method of sending the contents of the change of allocation of the volume 19 to the general manager. For this reason, it is the same as the first embodiment except the processing of FIG. 13 of the first embodiment, and so a detailed description thereof will be omitted.

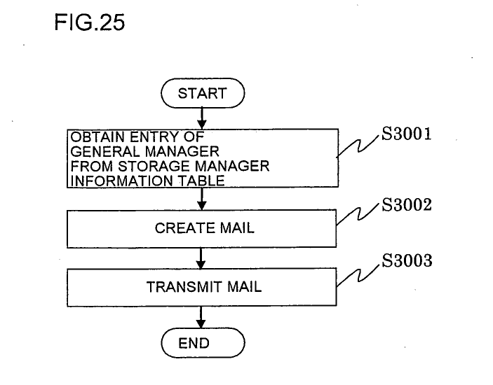

FIG. 25 shows a detailed processing flow of the step S1009 of FIG. 10 of the third embodiment. As for the volume allocation confirmation program 40, the sending process 42 obtains the entry indicating the information on the general manager from the storage manager information table 80 (S3001) The sending process 42 obtains the entry of which value of the field 81 indicating the management subject of the storage manager information table 80 is the “entirety” representing the entry of the general manager. Next, it creates the mail (S3002). The text of this mail has the entry of volume allocation design table 50 stored as the added volume information in the step S1204 of FIG. 12, the entry of the storage setting information table 60 stored as the deleted volume information in the step S1209 of FIG. 12, the entry of the storage setting information table 60 stored as the changing volume allocation information in the step S1106 of FIG. 11, the entry of volume allocation design table 50 stored as the changing volume allocation information in the step S1106 of FIG. 16, and the values of the fields set therein. And the send mail process 47 transmits the mail created in the step S3002 to the mail address set in the field 84 of the storage manager information table 80 obtained in the step S3001 (S3003) Here, the mail server 13 as the destination of the mail needs to be connected to the network capable of communication with the management computer 1 as in the first embodiment. In FIG. 1, the mail server 13 is connected to the management network 6.

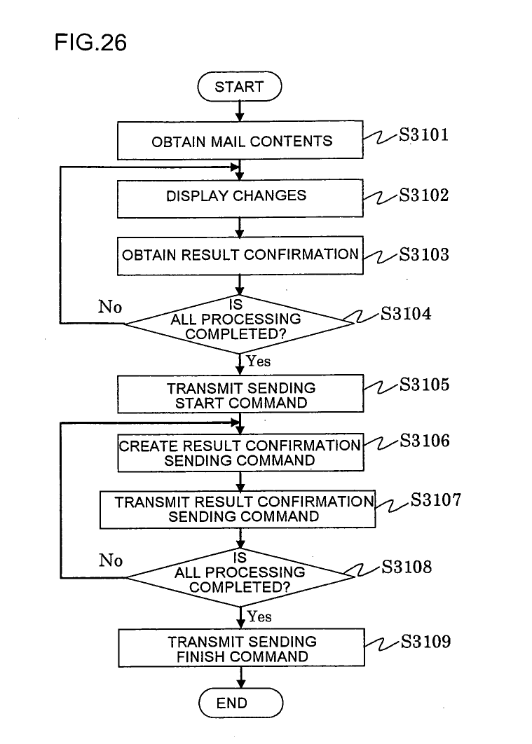

Next, a description will be given as to the processing of the confirm changes program 100 operating on the management terminal 4 in the third embodiment. FIG. 26 shows a processing flow of the confirm changes program 100 in the third embodiment. First, the confirm changes program 100 has the read mail process 105 read the mail notifying the change of allocation of the volume 19 received by the mail client 106, and converts the contents thereof to the form of the volume allocation changes sending command 210 (S3101). Next, the display changes process 102 displays on the display 97 the contents of each of the volume allocation changes sending commands 210 to which the contents of the mail has been converted in the step S3101 (S3102). The contents displayed in this case are different depending on the contents of the volume allocation changes sending command 210.

In the case where the value of the field 211 of the volume allocation changes sending command 210 is “3,” that is, in the case where the volume 19 is newly added, the volume addition confirmation screen 300 of FIG. 17 is displayed. The general manager selects the OK button 304 in the case of permitting the addition of the volume 19 by referring to the contents displayed on the volume addition confirmation screen 300, and selects the NG button 305 in the case of not permitting the addition of the volume 19.

In the case where the value of the field 211 of the volume allocation changes sending command 210 is “4,” that is, in the case where the volume 19 is deleted, a volume deletion confirmation screen 310 of FIG. 18 is displayed. The general manager selects the OK button 314 in the case of permitting the deletion of the volume 19 by referring to the contents displayed on the volume deletion confirmation screen 310, and selects the NG button 315 in the case of not permitting the deletion of the volume 19.

In the case where the value of the field 211 of the volume allocation changes sending command 210 is “5,” that is, in the case where the allocation of the volume 19 is changed, a changes confirmation screen 320 of FIG. 19 is displayed. The general manager selects the OK button 325 in the case of permitting the change of allocation of the volume 19 by referring to the contents displayed on the changes confirmation screen 320, and selects the NG button 326 in the case of not permitting the change of allocation of the volume 19.

In FIG. 26, the confirm changes program 100 has the input result confirmation process 103 obtain the button selected by the general manager on the screen displayed in the step S3102 (S3103). Next, the send result confirmation process 104 checks whether or not the processing of the steps S3102 and S3103 is completed with all the volume allocation changes sending commands 210 created in the step S3101 (S3104). If not completed, it moves on to the step S3102 and performs the processing for the contents of the next volume allocation changes sending command 210. If completed, it moves on to a step S3105. The send result confirmation process 104 transmits to the management computer 1 the sending start command indicating a start of sending the result confirmed by the general manager obtained in the step S3103 to the management computer 1 (S3105). Next, the result confirmation sending command 220 of FIG. 16C is created (S3106). Next, the result confirmation sending command created in the step S3106 is transmitted to the management computer 1 (S3107). And it is checked whether or not sending of all the result confirmations of the general manager obtained in the steps S3102 and S3105 to the management computer 1 has been completed (S3108). If not completed, it moves on to the step S3106 and processes the next result confirmation. If completed, it moves on to the step S3109 and transmits the sending finish command to the management computer 1 (S3109) so as to finish the processing.

According to the third embodiment, the processing of the volume allocation confirmation program 40 on receiving the result confirmation sending command 220 is the same as that of the first embodiment, and so a description thereof will be omitted.

As described above, the third embodiment of the volume allocation confirmation method of the present invention has the same effects as the first embodiment.

Another Embodiment 1 of the present invention is a computer system, wherein the management computer notifies a manager of the computer system of the configuration information to be changed by the design information and the design information out of existing configuration information on the storage device, and receives a result of having the notified changes confirmed by the manager of the computer system to perform the configuration on the storage device in compliance with the design information.

A further Embodiment 2 of the present invention is the computer system according to the Embodiment 1, wherein the management computer notifies the storage manager that the design information on the storage device is problematic in the case where the result of confirmation by the manager of the computer system indicates that the changes have problems.

A further Embodiment 3 of the present invention is the computer system according to the Embodiment 1 or 2, wherein the management computer includes a memory unit for storing first information indicating a method of notifying the changes and a notified party and second information indicating a method of notifying the result of having the notified changes confirmed and a notified party, identifies the method of notifying the changes and the notified party from the first information in the memory unit to notify the identified notified party of the changes by the identified notifying method, and identifies the method of notifying the result of confirmation of the changes and the notified party from the second information in the memory unit to notify the identified notified party of the problem by the identified notifying method.

A further Embodiment 4 of the present invention is the computer system according to the Embodiment 3, wherein, in the case where the first information notified party is information for identifying a second management computer having a display and an input device and used by the manager of the computer system, the management computer notifies the changes to a second management computer of the first information notified party and receives the result of confirmation by the manager of the computer system from the second management computer.

A further Embodiment 5 of the present invention is a management computer configuring a computer system with at least one host computer and at least one storage device for providing at least one volume to the host computer via at least one network and connected to the storage device via the network, wherein, when a storage manager configures volume allocation of the storage device, configuration information on the volume allocation of the storage device is gathered from the storage device and a comparison is made between design information on the volume allocation to be configured on the storage device inputted by the storage manager and the gathered configuration information on the volume allocation so as to identify changes.

A further Embodiment 6 of the present invention is the management computer according to the Embodiment 5, wherein it notifies a manager of the computer system of the configuration information to be changed by the design information and the design information out of existing configuration information on the storage device, and receives a result of having the notified changes confirmed by the manager of the computer system to perform the configuration on the storage device in compliance with the design information.

A further Embodiment 7 of the present invention is the management computer according to the Embodiment 6, wherein it notifies the storage manager that the design information on the storage device is problematic in the case where the result of confirmation by the manager of the computer system indicates that the changes have problems.

A further Embodiment 8 of the present invention is the management computer according to any one of the Embodiments 5 to 7, wherein it includes a memory unit for storing first information indicating a method of notifying the changes and a notified party and second information indicating a method of notifying the result of confirmation of the changes and a notified party, identifies the method of notifying the changes and the notified party from the first information in the memory unit to notify the identified notified party of the changes by the identified notifying method, and identifies the method of notifying the result of confirmation of the changes and the notified party from the second information in the memory unit to notify the identified notified party of the problem by the identified notifying method.

A further Embodiment 9 of the present invention is the management computer according to the Embodiment 8, wherein, in the case where the first information notified party is information for identifying a second management computer having a display and an input device and used by the manager of the computer system, the management computer notifies the changes to the second management computer of the first information notified party and receives the result of confirmation by the manager of the computer system from the second management computer.

A further Embodiment 10 of the present invention is a storage device for providing at least one volume to at least one host computer via at least one network, wherein, when a storage manager configures volume allocation of the storage device itself or another storage device, configuration information on the volume allocation of the storage device is gathered from the storage device and a comparison is made between design information on the volume allocation to be configured on the storage device inputted by the storage manager and the gathered configuration information on the volume allocation so as to identify changes.

A further Embodiment 11 of the present invention is the storage device according to the Embodiment 10, wherein it notifies a manager of the computer system of the configuration information to be changed by the design information and the design information out of existing configuration information on the storage device itself or another storage device, and receives a result of having the notified changes confirmed by the manager of the computer system to perform the configuration on the storage device in compliance with the design information.

A further Embodiment 12 of the present invention is the storage device according to the Embodiment 11, wherein it notifies the storage manager that the design information on the storage device itself or another storage device is problematic in the case where the result of confirmation by the manager of the computer system indicates that the changes have problems.

A further Embodiment 13 of the present invention is the storage device according to any one of the Embodiments 10 to 12, wherein it includes a memory unit for storing first information indicating a method of notifying the changes and a notified party and second information indicating a method of notifying the result of confirmation of the changes and a notified party, identifies the method of notifying the changes and the notified party from the first information in the memory unit to notify the identified notified party of the changes by the identified notifying method, and identifies the method of notifying the result of confirmation of the changes and the notified party from the second information in the memory unit to notify the identified notified party of the problem by the identified notifying method.

A further Embodiment 14 of the present invention is the storage device according to the Embodiments 13, wherein, in the case where the first information notified party is information for identifying a management computer having a display and an input device and used by the manager of the computer system, it notifies the changes to the management computer of the first information notified party and receives the result of confirmation by the manager of the computer system from the management computer.

A further Embodiment 15 of the present invention is a volume allocation confirmation method for a computer system configured by at least one host computer, at least one storage device for providing at least one volume to the host computer via at least one network and a management computer connected to the storage device via the network, wherein, when a storage manager configures volume allocation of the storage device, the method performs steps of: gathering configuration information on the volume allocation of the storage device from the storage device; and making a comparison between design information on the volume allocation to be configured on the storage device inputted by the storage manager and the gathered configuration information on the volume allocation so as to identify changes.

A further Embodiment 16 of the present invention is the volume allocation confirmation method according to the Embodiment 15, wherein it performs the steps of: notifying a manager of the computer system of the configuration information to be changed by the design information and the design information out of existing configuration information on the storage device; receiving a result of having the notified changes confirmed by the manager of the computer system, and performing the configuration on the storage device in compliance with the design information.

A further Embodiment 17 of the present invention is the volume allocation confirmation method according to the Embodiment 16, wherein it performs a step of notifying the storage manager that the design information on the storage device is problematic in the case where the result of confirmation by the manager of the computer system indicates that the changes have problems.

A further Embodiment 18 of the present invention is the volume allocation confirmation method according to any one of the Embodiments 15 to 17, wherein it performs the steps of: identifying a method of notifying the changes and a notified party from first information in the memory unit storing the first information indicating the method of notifying the changes and the notified party and second information indicating a method of notifying the result of confirmation of the changes and the notified party; notifying the identified notified party of the changes by the identified notifying method; identifying the method of notifying the result of confirmation of the changes and the notified party from the second information in the memory unit; and notifying the identified notified party of the problem by the identified notifying method.

A further Embodiment 19 of the present invention is the volume allocation confirmation method according to the Embodiment 18, wherein it performs the steps of: in the case where the first information notified party is information for identifying a second management computer having a display and an input device and used by the manager of the computer system, notifying the changes to the second management computer of the first information notified party; and notifying the result of confirmation by the manager of the computer system from the second management computer to the management computer.

What is claimed is:

1. A computer system comprising:
at least one host computer;
at least one storage device for providing at least one volume to the host computer via at least one network; and
a management computer connected to the storage device via the network, wherein
when a storage manager configures volume allocation of the storage device, the management computer gathers configuration information on the volume allocation of the storage device and makes a comparison between design information on the volume allocation to be configured on the storage device inputted by the storage manager and the gathered configuration information on the volume allocation so as to identify changes.

2. The computer system according to claim 1, wherein the management computer notifies a manager of the computer system of the configuration information to be changed by the design information and the design information out of existing configuration information on the storage device, and receives a result of having the notified changes confirmed by the manager of the computer system to perform the configuration on the storage device in compliance with the design information.

3. The computer system according to claim 2, wherein the management computer notifies the storage manager that the design information on the storage device is problematic in the case where the result of confirmation by the manager of the computer system indicates that the changes have problems.

4. The computer system according to any one of claims 1 to 3, wherein the management computer includes a memory unit for storing first information indicating a method of notifying the changes and a notified party and second information indicating a method of notifying the result of having the notified changes confirmed and a notified party, identifies the method of notifying the changes and the notified party from the first information in the memory unit to notify the identified notified party of the changes by the identified notifying method, and identifies the method of notifying the result of confirmation of the changes and the notified party from the second information in the memory unit to notify the identified notified party of the problem by the identified notifying method.

5. The computer system according to claim 4, wherein, in the case where the first information notified party is information for identifying a second management computer having a display and an input device and used by the manager of the computer system, the management computer notifies the changes to a second management computer of the first information notified party and receives the result of confirmation by the manager of the computer system from the second management computer.

6. A management computer configuring a computer system with at least one host computer and at least one storage device for providing at least one volume to the host computer via at least one network and connected to the storage device via the network, wherein, when a storage manager configures volume allocation of the storage device, configuration information on the volume allocation of the storage device is gathered from the storage device and a comparison is made between design information on the volume allocation to be configured on the storage device inputted by the storage manager and the gathered configuration information on the volume allocation so as to identify changes.

7. The management computer according to claim 6, wherein it notifies a manager of the computer system of the configuration information to be changed by the design information and the design information out of existing configuration information on the storage device, and receives a result of having the notified changes confirmed by the manager of the computer system to perform the configuration on the storage device in compliance with the design information.

8. The management computer according to claim 7, wherein it notifies the storage manager that the design information on the storage device is problematic in the case where the result of confirmation by the manager of the computer system indicates that the changes have problems.

9. The management computer according to any one of claims 6 to 8, wherein it includes a memory unit for storing first information indicating a method of notifying the changes and a notified party and second information indicating a method of notifying the result of confirmation of the changes and a notified party, identifies the method of notifying the changes and the notified party from the first information in the memory unit to notify the identified notified party of the changes by the identified notifying method, and identifies the method of notifying the result of confirmation of the changes and the notified party from the second information in the memory unit to notify the identified notified party of the problem by the identified notifying method.

10. The management computer according to claim 9, wherein, in the case where the first information notified party is information for identifying a second management computer having a display and an input device and used by the manager of the computer system, the management computer notifies the changes to the second management computer of the first information notified party and receives the result of confirmation by the manager of the computer system from the second management computer.

11. A storage device for providing at least one volume to at least one host computer via at least one network, wherein, when a storage manager configures volume allocation of the storage device itself or another storage device, configuration information on the volume allocation of the storage device is gathered from the storage device and a comparison is made between design information on the volume allocation to be configured on the storage device inputted by the storage manager and the gathered configuration information on the volume allocation so as to identify changes.

12. The storage device according to claim 11, wherein it notifies a manager of the computer system of the configuration information to be changed by the design information and the design information out of existing configuration information on the storage device itself or another storage device, and receives a result of having the notified changes confirmed by the manager of the computer system to perform the configuration on the storage device in compliance with the design information.

13. The storage device according to claim 12, wherein it notifies the storage manager that the design information on the storage device itself or another storage device is problematic in the case where the result of confirmation by the manager of the computer system indicates that the changes have problems.

14. The storage device according to any one of claims 11 to 13, wherein it includes a memory unit for storing first information indicating a method of notifying the changes and a notified party and second information indicating a method of notifying the result of confirmation of the changes and a notified party, identifies the method of notifying the changes and the notified party from the first information in the memory unit to notify the identified notified party of the changes by the identified notifying method, and identifies the method of notifying the result of confirmation of the changes and the notified party from the second information in the memory unit to notify the identified notified party of the problem by the identified notifying method.

15. The storage device according to claim 14, wherein, in the case where the first information notified party is information for identifying a management computer having a display and an input device and used by the manager of the computer system, it notifies the changes to the management computer of the first information notified party and receives the result of confirmation by the manager of the computer system from the management computer.

16. A volume allocation confirmation method for a computer system configured by at least one host computer, at least one storage device for providing at least one volume to the host computer via at least one network and a management computer connected to the storage device via the network, wherein, when a storage manager configures volume allocation of the storage device, the method performs steps of:
gathering configuration information on the volume allocation of the storage device from the storage device; and
making a comparison between design information on the volume allocation to be configured on the storage device inputted by the storage manager and the gathered configuration information on the volume allocation so as to identify changes.

17. The volume allocation confirmation method according to claim 16, wherein it performs the steps of:
notifying a manager of the computer system of the configuration information to be changed by the design information and the design information out of existing configuration information on the storage device;
receiving a result of having the notified changes confirmed by the manager of the computer system, and
performing the configuration on the storage device in compliance with the design information.

18. The volume allocation confirmation method according to claim 17, wherein it performs a step of notifying the storage manager that the design information on the storage device is problematic in the case where the result of confirmation by the manager of the computer system indicates that the changes have problems.

19. The volume allocation confirmation method according to any one of claims 16 to 18, wherein it performs the steps of:
identifying a method of notifying the changes and a notified party from first information in the memory unit storing the first information indicating the method of notifying the changes and the notified party and second information indicating a method of notifying the result of confirmation of the changes and the notified party;
notifying the identified notified party of the changes by the identified notifying method;
identifying the method of notifying the result of confirmation of the changes and the notified party from the second information in the memory unit; and
notifying the identified notified party of the problem by the identified notifying method.

20. The volume allocation confirmation method according to claim 19, wherein it performs the steps of:
in the case where the first information notified party is information for identifying a second management computer having a display and an input device and used by the manager of the computer system,
notifying the changes to the second management computer of the first information notified party; and
notifying the result of confirmation by the manager of the computer system from the second management computer to the management computer.
